(19) United States
(12) Patent Application Publication
(10) Pub. No.: US 2015/0193815 A1
(43) Pub. Date: Jul. 9, 2015

(54) VALIDATING ADVERTISEMENT PREDICTIONS USING ADVERTISEMENT EXPERIMENTS

(71) Applicants: Adam Isaac Juda, New York, NY (US); Jonathan Feldman, New York, NY (US); David Vespe, New York, NY (US)

(72) Inventors: Adam Isaac Juda, New York, NY (US); Jonathan Feldman, New York, NY (US); David Vespe, New York, NY (US)

(73) Assignee: Google Inc.

(21) Appl. No.: 13/569,112

(22) Filed: Aug. 7, 2012

(51) Int. Cl. G06Q 30/02

(52) U.S. Cl. CPC G06Q 30/0244; G06Q 30/0275

(57) ABSTRACT

Experiment performance data associated with a first advertisement campaign is generated during a first advertisement campaign experiment. The experiment performance data includes a first set of experiment performance data and a second set of experiment performance data. A first set of simulated performance data for the first advertisement campaign using first set of auction instances with the advertisement campaign setting having second advertisement campaign value is generated. A second set of simulated performance data for the first advertisement campaign using the second set of auctions instances with the advertisement campaign setting having the first advertisement campaign value is generated. Accuracy of the first set of performance data and the second set of performance data is determined by comparing the first performance data to the second set of experiment performance data, and by comparing the second performance data to the first set of experiment performance data.

### BACKGROUND

To reach more customers, companies increasingly advertise their products and services online using online advertisement systems. The advertisement systems enable advertisers to create and manage custom online advertising campaigns. Advertisers need to regularly make changes to their advertising campaign settings in order to continuously attract new customers to their websites and remain competitive with other advertisers offering similar products and services. However, optimizing advertising campaigns to meet advertiser goals and determining the impact of various advertising campaign changes on performance of advertisements can be challenging.

### SUMMARY

One approach to determining accuracy of advertisement performance predictions using advertisement experiments is a method. The method includes receiving experiment performance data associated with a first advertisement campaign. The experiment performance data is generated during a first advertisement campaign experiment. The experiment performance data includes a first set of experiment performance data and a second set of experiment performance data. During the advertisement campaign experiment, a first set of auction instances for advertisement space used the first advertisement campaign with a first advertisement campaign setting having a first advertisement campaign value. During the advertisement campaign experiment, a second set of auction instances for advertisement space used the first advertisement campaign with the first advertisement campaign setting having a second advertisement campaign value.

The method further includes generating a first set of simulated performance data for the first advertisement campaign using the first set of auction instances with the first advertisement campaign setting having the second advertisement campaign value. The method further includes generating a second set of simulated performance data for the first advertisement campaign using the second set of auctions instances with the first advertisement campaign setting having the first advertisement campaign value. The method further includes determining accuracy of the first set of performance data and the second set of performance data by comparing the first performance data to the second set of experiment performance data, and by comparing the second performance data to the first set of experiment performance data.

Another approach to determining accuracy of advertisement performance predictions using advertisement experiments is a system. The system includes one or more processing circuits configured to receive experiment performance data associated with a first advertisement campaign. The experiment performance data is generated during a first advertisement campaign experiment. The experiment performance data includes a first set of experiment performance data and a second set of experiment performance data. During the advertisement campaign experiment, a first set of auction instances for advertisement space used the first advertisement campaign with a first advertisement campaign setting having a first advertisement campaign value. During the advertisement campaign experiment, a second set of auction instances for advertisement space used the first advertisement campaign with the first advertisement campaign setting having a second advertisement campaign value.

The one or more processing circuits configured are further configured to generate a first set of simulated performance data for the first advertisement campaign using the first set of auction instances with the first advertisement campaign setting having the second advertisement campaign value. The one or more processing circuits configured are further configured to generate a second set of simulated performance data for the first advertisement campaign using the second set of auctions instances with the first advertisement campaign setting having the first advertisement campaign value. The one or more processing circuits configured are further configured to determine accuracy of the first set of performance data and the second set of performance data by comparing the first performance data to the second set of experiment performance data, and by comparing the second performance data to the first set of experiment performance data.

Another approach to determining accuracy of advertisement performance predictions using advertisement experiments is a computer-readable medium. The computer-readable medium stores instructions that when executed by one or more processors receive experiment performance data associated with a first advertisement campaign. The experiment performance data is generated during a first advertisement campaign experiment. The experiment performance data includes a first set of experiment performance data and a second set of experiment performance data. During the advertisement campaign experiment, a first set of auction instances for advertisement space used the first advertisement campaign with a first advertisement campaign setting having a first advertisement campaign value. During the advertisement campaign experiment, a second set of auction instances for advertisement space used the first advertisement campaign with the first advertisement campaign setting having a second advertisement campaign value.

The instructions when executed further generate a first set of simulated performance data for the first advertisement campaign using the first set of auction instances with the first advertisement campaign setting having the second advertisement campaign value. The instructions when executed further generate a second set of simulated performance data for the first advertisement campaign using the second set of auctions instances with the first advertisement campaign setting having the first advertisement campaign value. The instructions when executed further determine accuracy of the first set of performance data and the second set of performance data by comparing the first performance data to the second set of experiment performance data, and by comparing the second performance data to the first set of experiment performance data.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 illustrates a block diagram of an example environment in which an advertisement system manages advertising services in accordance with an illustrative embodiment;

FIG. 2 illustrates a block diagram for validating simulated performance data using experiment performance data in accordance with an illustrative embodiment;

FIGS. 3A-C illustrate user interfaces for displaying visualization of the simulated performance data and experiment performance data in accordance with an illustrative embodiment;

FIG. 4 illustrates a flow diagram of a process for validating simulated performance data using advertising campaign experiment in accordance with an illustrative embodiment; and

FIG. 5 is a block diagram of a computer system in accordance with an illustrative embodiment.

Like reference numbers and designations in the various drawings indicate like elements.

### DETAILED DESCRIPTION

In an advertisement management system, advertisers can create one or more advertising campaigns to advertise various products and services online. For example, the advertiser can organize the advertising campaigns by specific product or product class. At the advertising campaign level, the advertiser can select a daily budget, geographic targeting, language targeting, distribution preferences, end dates, etc. Any single advertising campaign may be as simple as a single keyword bid, or as complicated as multiple advertising groups with multiple keywords.

Each advertising campaign can include one or more advertising groups. An advertising group can focus on a single product, a brand, etc. In turn, for each advertising group, the advertiser can create custom advertisements, and select one or more keywords, targeting services and/or products that the advertisements promote. Cost per click (CPC) bids, indicating a price the advertiser is willing to pay for clicks on the advertisements, can be set at the advertising group level or for each individual keyword.

An advertiser can manually modify various settings associated with an advertising campaign including making changes to bids, keywords, landing pages, etc. To assist the advertiser with campaign optimization, an advertisement management system 110 can enable the advertiser to experiment with advertisement campaign changes. In particular, using one or more user interfaces in the advertisement management system 110, the advertiser can create an experiment that holds back a portion of random user traffic to test an unmodified version of the advertising campaign against a modified version of the advertising campaign.

The advertisement management system 110 can generate suggested changes that would improve performance of the advertiser's campaigns (e.g., increase number of impressions and clicks on the advertisements). For example, a list of new keywords may be presented to the advertiser. In another example, changes to bids or budgets may be suggested. The advertiser can manually select one or more changes from the various changes suggested by the advertisement management system 110, and run experiments based on the selected changes.

Upon completion of the experiment, the advertiser is presented with a visualization of results of the experiment illustrating the impact the advertising campaign changes had on the performance of the advertising campaign. Based on the results, of the experiment, the user can determine whether to permanently update the advertisement campaign with experimented advertisement campaign changes.

The advertisement management system 110 can generate advertising campaign performance predictions. In some embodiments, the predictions can include estimates of performance regarding clicks, cost, impressions and other advertisement performance data that the advertisements in the advertisement campaign would have received over a predetermined period of time if the advertisement campaign had set different settings (e.g., different bids). For example, if an advertiser has set a maximum cost per click bid of $1 for an advertising campaign, system 110 could show the advertiser predicted performance data such as clicks, cost, and impressions that the advertising campaign is estimated to receive if the advertiser were to increase the maximum cost per click to $2.

To verify and validate the predictions generated by the advertisement management system 110, advertising campaign experimental data can be used. In particular, experiments with advertising campaign setting changes conducted by an advertiser using an advertising campaign experiments engine are used in measuring accuracy of predictions generated by an advertisement change simulation engine. In some embodiments, the advertising campaign experiments engine automatically conducts experiments with advertisement campaign settings. In these embodiments, the performance data generated by these automatic experiments are utilized for measures the simulated performance data.

The advertisement change simulation engine estimates what would have happened in the past had the advertiser used different advertising campaign settings (e.g., different bid level, different or modified keyword, different budget, etc.). For example, the advertisement change simulation engine can predict how many clicks and impressions the advertising campaign would have received for a particular keyword, if a $4 bid was used instead of a $1 bid for a particular keyword or ad group associated with the advertisement campaign.

The predictions made by the advertisement change simulation engine are compared against the results of actual advertising campaign experiments performed using the experiment engine 122. For each experiment with a control setting set at a first level and an experiment setting set at a second level, the auction instances that used the setting at the first level are separated from those instances that use the setting at the second level. For example, a control bid may be set at a first bid level and an experiment bid may be set at a second bid level. The bid simulation system algorithms are applied to the auction instances at the first bid level, simulating what would have happened at the second bid level, and vice versa. The simulated observation performance data is compared to what actually happened during auction instances at the two bid levels. Various metrics are calculated from this comparison including average discrepancy percentage between actual results and simulated results.

In other embodiments, an advertiser can change a bid week-over-week. In these embodiments, the ad change simulation engine 124 can simulate first week's user traffic with second week's bid, and then compare the simulated performance second week's actual performance data. However, a number of external factors can make second week performance data differ from first week performance data for reasons other than bid change.

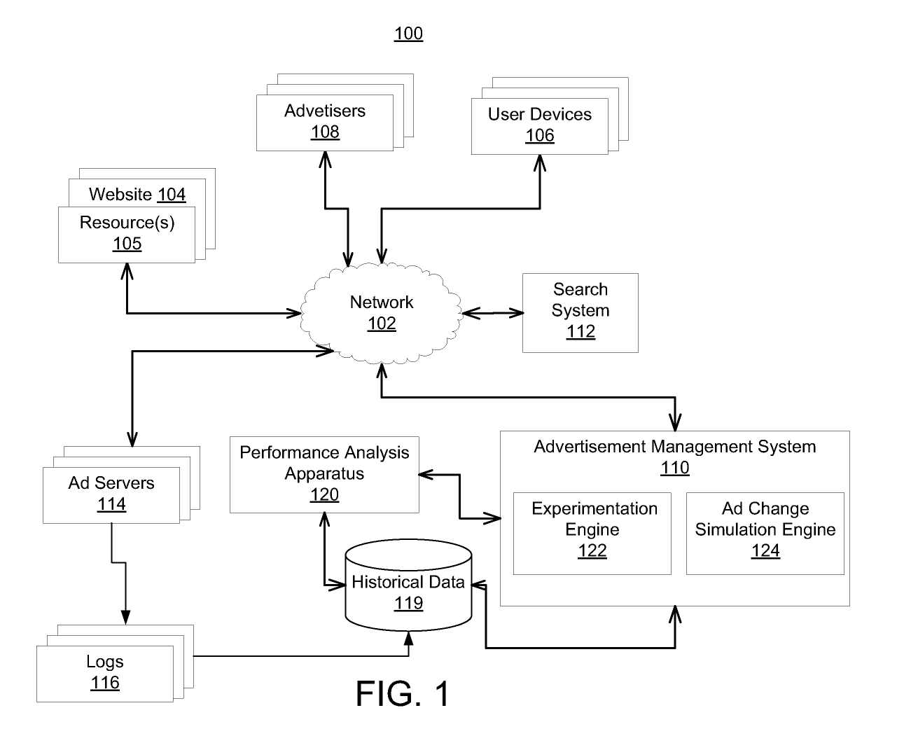

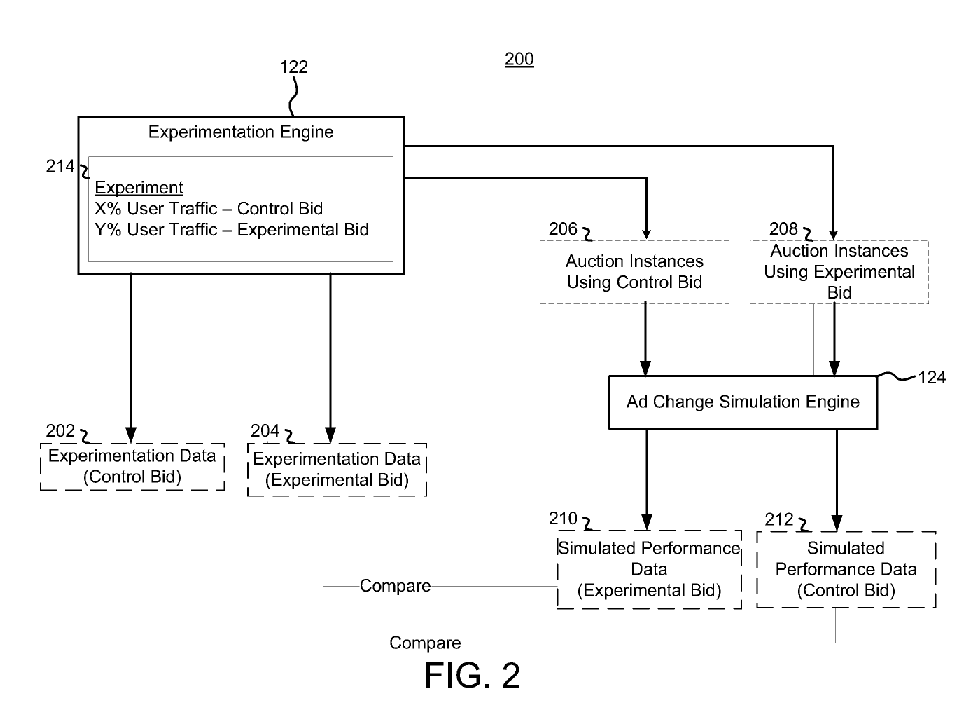

FIG. 1 is a block diagram of an example environment 100 in which the advertisement management system 110 manages advertising services. Environment 100 includes a network 102, such as a local area network (LAN), a wide area network (WAN), a wireless network, the Internet, or a combination thereof. The network 102 connects websites 104, user devices 106, advertisers 108, and the advertisement management system 110. Environment 100 may include any number of websites 104, user devices 106, and advertisers 108.

A website 104 includes one or more resources 105 associated with a domain name and hosted by one or more servers. An example website is a collection of web pages formatted in hypertext markup language (HTML) that can contain text, images, multimedia content, and programming elements, such as scripts.

The resource 105 is any data that can be provided over the network 102. The resource 105 is identified by a resource address that is associated with the resource 105, such as a URL. Resources 105 can include web pages, word processing documents, portable document format (PDF) documents, images, video, programming elements, interactive content, and feed sources, to name only a few. Resources 105 can include content, such as words, phrases, images and sounds, that may include embedded information (such as meta-information in hyperlinks) and/or embedded instructions. Embedded instructions can include code that is executed at a user's device, such as in a web browser. Code can be written in languages, such as, JavaScript® or ECMAScript®.

A user device 106 is an electronic device that is under the control of a user. User device 106 is configured to request and receive resources 105 over the network 102. Example user devices 106 include personal computers, mobile communication devices, and other devices that can send and receive data over the network 102. In some implementations, the user devices 106 may include a user application, such as a web browser, to facilitate the sending and receiving of data over the network 102.

The user devices 106 can request resources 105 from a website 104. In turn, data representing the resource 105 can be provided to user device 106 for presentation by user device 106 (e.g., on an electronic display, as an audible sound via a speaker, or a combination thereof). The data representing the resource 105 can include data specifying a portion of the resource or a portion of a user display (e.g., a presentation location of a pop-up window or in a slot of a web page) in which advertisements can be presented. These specified portions of the resource 105 or user display are referred to as advertisement slots.

To facilitate searching of the vast number of resources 105 accessible over the network 102, the environment 100 may include a search system 112 that identifies resources 105 by crawling and indexing resources 105 provided on websites 104. Data about resources 105 can be indexed based on the resource 105 with which the data is associated. The indexed and, optionally, cached copies of resources 105 are stored in a search index (not shown).

User devices 106 can submit search queries to the search system 112 over the network 102. In response, the search system 112 accesses the search index to identify resources 105 that are relevant to the search query. In one illustrative embodiment, a search query includes one or more keywords. The search system 112 identifies resources 105 that are responsive to the query, provides information about resources 105 in the form of search results and returns the search results to the user devices 106 in search results pages. A search result can include data generated by the search system 112 that identifies the resource 105 that is responsive to a particular search query, and can include a link to the resource 105. An example search result can include a web page title, a snippet of text or a portion of an image extracted from a web page, a rendering of the resource 105, and the URL of the web page. Search results pages can also include one or more advertisement slots in which advertisements can be presented.

A search result page can be sent with a request from the search system 112 for the web browser of the user device 106 to set an HTTP (HyperText Transfer Protocol) cookie. A cookie can represent, for example, a particular user device 106 and a particular web browser. For example, the search system 112 includes a server that replies to the query by sending the search results page in an HTTP response. This HTTP response includes instructions (e.g., a set cookie instruction) that cause the browser to store a cookie for the site hosted by the server or for the domain of the server. If the browser supports cookies and cookies are enabled, every subsequent page request to the same server or a server within the domain of the server will include the cookie. The cookie can store a variety of data, including a unique or semi-unique identifier. The unique or semi-unique identifier can be anonymized and is not connected with user names. Because HTTP is a stateless protocol, the use of cookies allows an external service, such as the search system 112 or other system, to track particular actions and status of a user over multiple sessions. A user may opt out of tracking user actions, for example, by disabling cookies in the browser's settings.

When the resource 105 or search results are requested by a user device 106 or provided to user device 106, the advertisement management system 110 receives a request for advertisements to be provided with the resource 105 or search results. The request for advertisements can include characteristics of the advertisement slots that are defined for the requested the resource 105 or search results page, and can be provided to advertisement management system 110. For example, a reference (e.g., URL) to the resource 105 for which the advertisement slot is defined, a size of the advertisement slot, and/or media types that are available for presentation in the advertisement slot can be provided to advertisement management system 110. Similarly, keywords (i.e., one or more words that are associated with content) associated with a requested the resource 105 (“resource keywords”) or a search query for which search results are requested can also be provided to the advertisement management system 110 to facilitate identification of advertisements that are relevant to the resource 105 or search query.

Based on the data included in the request for advertisements, the advertisement management system 110 can select advertisements that are eligible to be provided in response to the request (“eligible advertisements”). For example, eligible advertisements can include advertisements having characteristics matching the characteristics of advertisement slots and that are identified as relevant to specified resource keywords or search queries. In some implementations, advertisements having targeting keywords that match the resource keywords, the search query, or portions of the search query are selected as eligible advertisements by advertisement management system 110.

The advertisement management system 110 selects an eligible advertisement for each advertisement slot of the resource 105 or of a search results page. The resource 105 or search results page is received by the user device 106 for presentation by the user device 106. User interaction data representing user interactions with presented advertisements can be stored in a historical data store 119. For example, when an advertisement is presented to the user via an ad server 114, data can be stored in a log file 116. The log file 116 can be aggregated with other data in a historical data store 119. Accordingly, the historical data store 119 contains data representing the advertisement impression. For example, the presentation of an advertisement is stored in response to a request for the advertisement that is presented. For example, the ad request can include data identifying a particular cookie, such that data identifying the cookie can be stored in association with data that identifies the advertisement(s) that were presented in response to the request. In some implementations, the data can be stored directly to the historical data store 119.

Similarly, when a user selects to traverse a link (e.g., a hyperlink, a presented advertisement, etc.), data representing the selection of the link can be stored in the log file 116, a cookie, or the historical data store 119. In some implementations, the data is stored in response to a request for a web page that is linked to an advertisement. For example, the user selection of the advertisement can initiate a request for presentation of a web page that is provided by (or for) the advertiser. The request can include data identifying the particular cookie for the user device, and this data can be stored in the advertisement data store.

User interaction data can be associated with unique identifiers that represent a corresponding user device with which the user interactions were performed. For example, in some implementations, user interaction data can be associated with one or more cookies. Each cookie can include content which specifies an initialization time that indicates a time at which the cookie was initially set on the particular user device 106. In further implementations, additional information may be collected about a particular user. For example, additional information may include information relating to the user's demographics, geographic location (e.g., based on a GPS function in a mobile device, based on an IP address, etc.), system information (e.g., which web browser is being use, the type of computing device used, etc.), and any other type of information about a user's interaction with environment 100.

Log files 116, or historical data store 119, also store references to advertisements and data representing conditions under which each advertisement was selected for presentation to a user. For example, the historical data store 119 can store targeting keywords, bids, and other criteria with which eligible advertisements are selected for presentation. Additionally, the historical data store 119 can include data that specifies a number of impressions for each advertisement and the number of impressions for each advertisement can be tracked, for example, using the keywords that caused the advertisement impressions and/or the cookies that are associated with the impressions. Data for each impression can also be stored so that each impression and user selection can be associated with (i.e., stored with references to and/or indexed according to) the advertisement that was selected and/or the targeting keyword that caused the advertisement to be selected for presentation.

Advertisers 108 can submit, to the advertisement management system 110, campaign parameters (e.g., targeting keywords and corresponding bids) that are used to control distribution of advertisements. Advertisers 108 can access the advertisement management system 110 to monitor performance of the advertisements that are distributed using the campaign parameters. For example, an advertiser can access a campaign performance report that provides a number of impressions (i.e., presentations), selections (i.e., clicks), and conversions that have been identified for the advertisements. The campaign performance report can also provide a total cost, a cost-per-click, and other cost measures for the advertisement over a specified period of time. In some embodiments, the campaign performance report or another report generated by the advertisement management system 110 displays to the advertiser results of experiments including ongoing and past experiments.

In some implementations, when a user accesses a web page, or another resource, from a referring web page (or other resource), the referring web page (or other resource) for that interaction can be identified, for example, by execution of code that is referenced by the web page being accessed and/or based on a URL that is used to access the web page. For example, a user can access an advertiser's website by selecting a link presented on a web page, for example, as part of a promotional offer by an affiliate of the advertiser. This link can be associated with a URL that includes data (i.e., text) that uniquely identifies the resource from which the user is navigating. For example, the link http://www.example.com/homepage/%affiliate_identifier%promotion_{—}1 specifies that the user navigated to the example.com web page from a web page of the affiliate that is associated with the affiliate identifier number that is specified in the URL, and that the user was directed to the example.com web page based on a selection of the link that is included in the promotional offer that is associated with promotion_{—}1. The user interaction data for this interaction (i.e., the selection of the link) can be stored in a database and used, as described below, to facilitate performance reporting and visualizing the flow of traffic in environment 100.

The advertisement management system 110 includes a performance analysis apparatus 120 that may use traffic and other data stored in logs 116, historical data 119, or elsewhere, to generate one or more flow visualizations of traffic in environment 100. For example, performance analysis apparatus 120 may analyze cookie data to determine how many users traverse from one of websites 104 to another. In some implementations, performance analysis apparatus 120 may aggregate sets of data into nodes and/or traffic paths for the visualization. Performance analysis apparatus 120 may also determine which nodes and traffic paths are displayed in a traffic flow visualization. For example, performance analysis apparatus 120 may utilize one or more scoring functions based on the amount of traffic between nodes to determine which traffic paths are displayed. The scoring function may also be based on level weights. For example, each of the traffic paths going from nodes A to B to C may have a level weight of 1, whereas a path that traverses directly from A to C may have a level weight of 2.

The advertisement management system 110 includes an experimentation engine 122 and an ad change simulation engine 124. The experimentation engine 122 enables advertisers to experiment with changes to various advertisement campaign settings (e.g., bid changes, keyword changes, budget changes, etc.). The ad change simulation engine 124 estimates advertisement campaign performance data (e.g., clicks, impressions, conversions, etc.) if the advertiser would have used a different advertisement campaign setting value (e.g., a different bid, keyword, and/or budget, etc.).

FIG. 2 is a block diagram illustrating validation of data generated by the ad change simulation engine 124 using experimentation data generated by the experimentation engine 122, in accordance with an illustrative embodiment. The experimentation engine 122 performs an experiment 214 with X % of user traffic attributed to a control bid, and Y % of user traffic attributed to an experimental bid. In some embodiments, the experiment is applied to a particular ad group of an advertisement campaign belonging to an advertiser. In other embodiments, the experiment is applied to a particular keyword of an ad group in the advertisement campaign. For example, the control bid (i.e., the original $1 bid set for the ad group) can be applied to 50% of user traffic, while the experimental bid (e.g., $2) can be applied to the remaining 50% of user traffic.

The experimentation engine 122 generates experimentation data 202 and 204 for the experiment 214. The experimentation data 202 includes experiment performance data that was a result of using the control bid for a portion of user traffic, while the experimentation data 204 includes experiment performance data that was a result of using the experimental bid for another portion of user traffic. Accordingly, the experiment 214 can have two “arms”, with the first “arm” of the experiment having the experimentation data 202 generated using the control bid, and the second “arm” of the experiment 214 having the experimentation data 204 using the experimental bid.

The experimentation data 202 and 204 can be stored and maintained in a single log or data storage, or multiple logs. The experimentation data 202 and 204 includes performance data such as clicks, impressions, conversions, cost, etc. For example, if the experiment was run for an ad group “high end purses” and a keyword “large tote” with a control bid of $1 and the experimental bid of $2, then the experimentation data can include total number of clicks, impressions, and conversions received at the $1 bid, as well as at the $2 bid.

Using auction instances 206 and 208, the ad change simulation engine 124 generates simulated performance data 210 and 212. The ad change simulation engine 124 can apply one or more simulation algorithms to the auction instances simulating what would have happened at the two different bids. Similarly to the observation data 202 and 204, the simulated performance data 210 and 212 can include performance data (e.g., clicks, impressions, conversions, cost, etc.).

The experimentation data 202 and 204 as well as the simulated performance data 210 and 212 can be aggregated to obtain various comparison metrics. The comparison metrics can indicate the accuracy of the predicted performance data generated by the ad change simulation engine 124. In some embodiments, reports are generated displaying the determined comparison metrics and other data associated with comparison of the simulated performance data and experimentation data. In other embodiments, any combination of comparison metrics are analyzed by the system 110 to determine accuracy of the predictions.

The comparison metrics can include average discrepancy percentage between actual results and simulated results, standard deviation of absolute differences, standard deviation of percentage differences, etc. As other examples, the comparison metrics can also include standard deviation, median absolute deviation, mean, median, quantiles, etc., of parameters such as log((predicted result)/(actual result))), predicted minus actual, predicted divided by actual, the “Z statistic” ((actual−predicted)/sqrt(predicted*(1−(predicted/X))) where X=impressions if clicks are being predicted, or X=clicks if conversions are being predicted), etc.

Other comparison metrics can be generated based on the experimentation data 202 and 204, and the simulated performance data 210 and 212. For example, the predicted vs. actual may be plotted, a regression line may be fit to this plot, and the “R-squared” statistic may be used on this regression to evaluate the quality of the prediction. An “R-squared” statistic may also be taken relative to the y=x line, rather than a regression line.

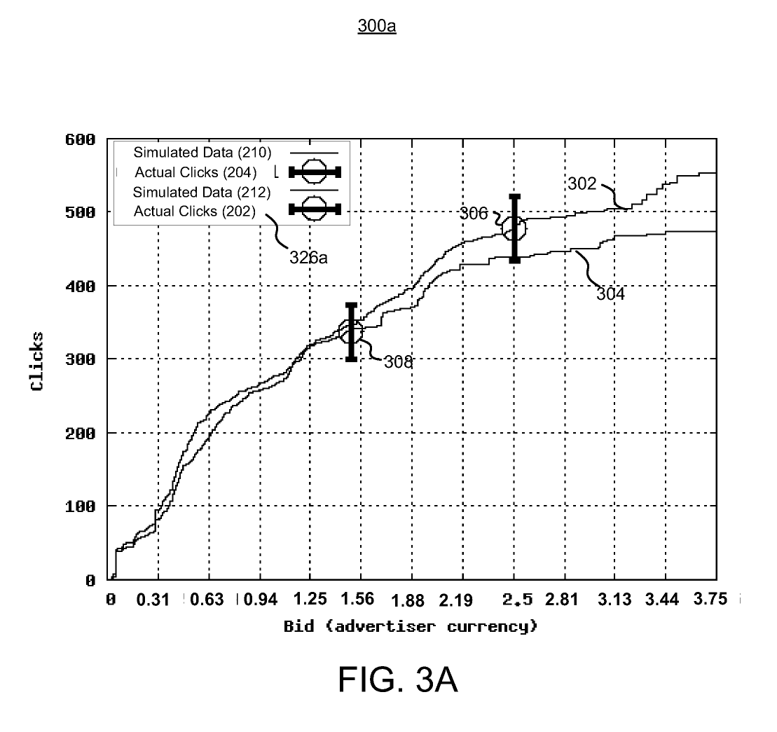

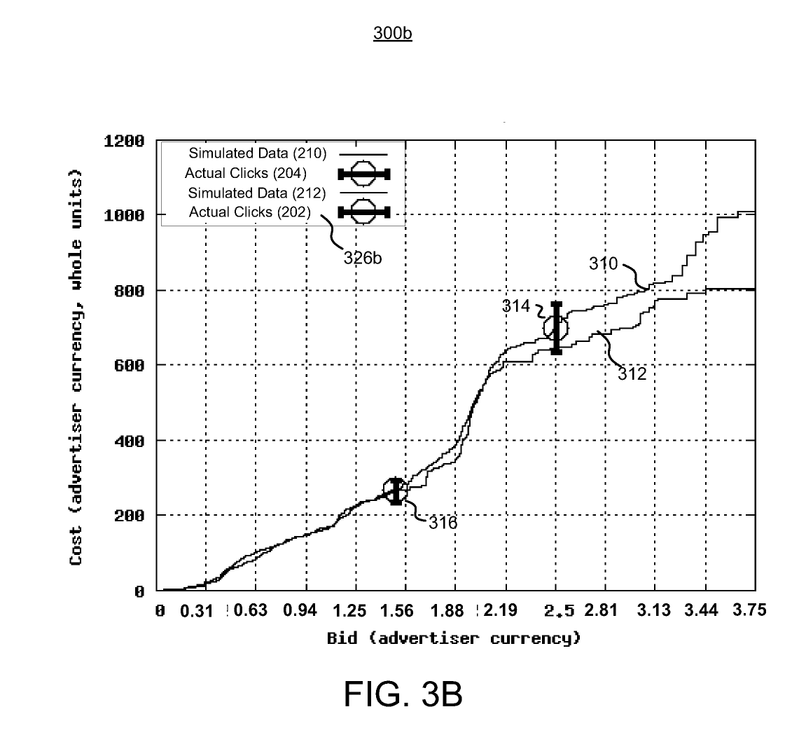

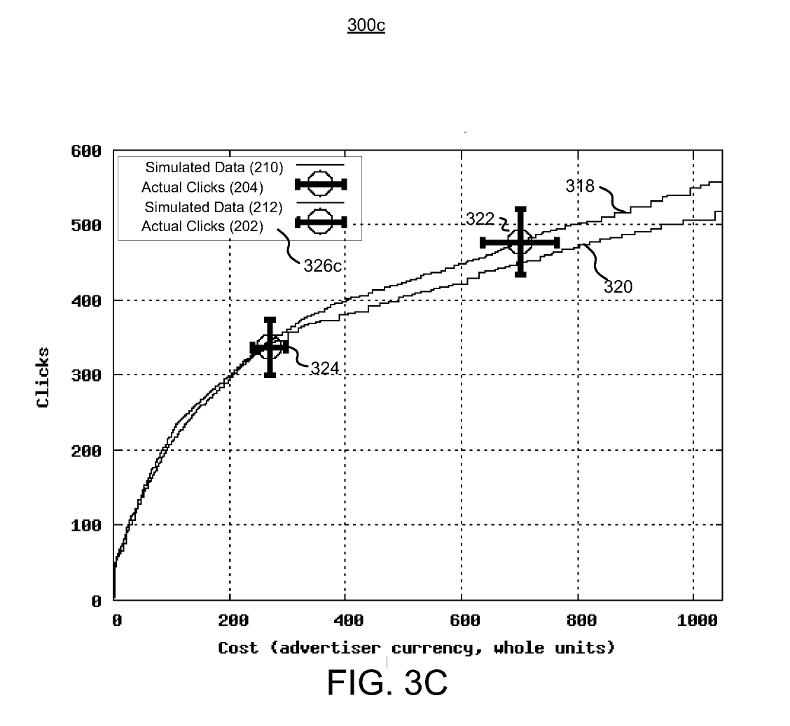

FIGS. 3A-C illustrate user interfaces displaying line graphs for determining accuracy of simulated advertisement performance predictions. The lines (e.g., 302, 304, 310, 312, 318, and 320) in the line graphs in the user interfaces 300a-c display simulated data generated during the experiment 214 in which a percentage of user traffic (e.g., 50%) received a control bid, and another percentage of user traffic (e.g., 50%) received an experimental bid. The experiment 214 may be associated with a particular ad group of an ad group campaign. During the experiment 214, the ad group can be cloned, and during simulation of predictions, at auction time, it is determined (e.g., randomly) which ad group (or which “arm” of the experiment 214) would receive a given impression.

For example, if the experiment 214 lasts for a week, the data displayed by the lines 302, 304, 310, 312, 318, and 320 reflects the simulated performance data generated during that period of time (or a sub-portion of that period of time) with part of user traffic receiving the control bid, and another part of traffic receiving the experimental bid. For example, if the experiment 214 is configured such that fifty percent of user traffic receives the control bid and fifty percent of traffic receives experimental bid, then during auction, it is determined (e.g., randomly), which bid is utilized. In other embodiments, time comparison of performance data (e.g., comparing last week's data to this week's data) is performed.

FIG. 3A illustrates a user interface 300a displaying how the total number of predicted clicks varies with a change in bid. The X-axis of the line graph is measuring bids at different bid levels (e.g., $0.31 bid, $0.63 bid, etc.), while the Y-axis is measuring the number of clicks received (e.g., 100 clicks, 200 clicks, 300 clicks). As shown in a legend 326a of the line graph, the simulated or predicted clicks shown in the line 302 represent the simulated performance data 210, while the clicks in line 304 represented simulated performance data 212. Both the simulated performance data 210 and 212 are generated by the ad change simulation engine 124 using experimentation data from a predetermined period of time (e.g., a day, a week, etc.) of the experiment 214 (i.e., entire duration of the experiment 214, or sub-portion of the experiment 214 duration). The line 302 and 304 shown in the line graph in the user interface 300a demonstrate predicted clicks at various bids (e.g., bid 0.31, bid 0.63, etc.).

A point 306 represents the actual number of clicks received during experiment 214 at the experimental bid level. Accordingly, the point 306 is determined based on an experiment conducted by the experiment engine 122 (e.g., for a particular ad group). The location of the point 306 in the line graph with respect to the lines 302 and 304 can be indicative of accuracy and/or internal consistency of the ad simulation engine 124. In some embodiments, the point 306 falling on the line 302 can indicate that the engine 124 is calculating simulated performance data e.g., simulated performance 210) accurately. The point 306 falling near the line 304, within the point's 306 confidence bounds or error bars can indicate accuracy of the simulated results generated by the engine 124. The error bars of the point 302 can be calculated utilizing a statistical method such as binomial distribution with clicks being considered random events.

The line 304 illustrates a visualization of the simulated performance data 212 generated by the engine 124 based on experimentation data 204 (i.e., an arm of the experiment 214 that utilized the experimental bid). The point 308 represents the actual number of clicks received by the advertisement campaign during the experiment 214 at the control bid level. The location of the point 308 in the line graph with respect to the lines 302 and 304 can be indicative of accuracy and/or internal consistency of the ad simulation engine 124. In particular, the point 308 falling on the line 304 can indicate that the engine 124 is calculating simulated performance data e.g., simulated performance 212) accurately. The point 308 falling near the line 302, within the point's 308 confidence bounds or error bars can indicate accuracy of the simulated results generated by the engine 124. The error bars of the point 304 can be calculated utilizing a statistical method such as binomial distribution with clicks being considered random events.

In some embodiments, the placement or location of the lines 302 and 304 in the line graph with respect to each other can indicate accuracy of the engine 124. For example, similar slopes of the lines 302 and 304 and/or a measurement of distances between the lines 302 and 304 (e.g., total area between the lines 302 and 304 as a measure of error) indicate that the engine 124 is generating accurate simulated performance data.

FIG. 3B illustrates a user interface 300b displaying how advertisement cost varies with a change in bid using simulated performance data 210 and 212 and experimentation data 202 and 204. The X-axis of the line graph is measuring bids at different bid levels (e.g., $0.31 bid, $0.63 bid, etc.), while the Y-axis is measuring the predicted incurred cost (e.g., $200, $400, etc.). As shown in a legend 326b, the simulated or predicted cost shown in the line 310 represent the simulated performance data 210, while the cost in line 312 represents simulated performance data 212. The lines 310 and 312 shown in the line graph in the user interface 300b demonstrate predicted cost at various bids (e.g., bid 0.31, bid 0.63, etc.).

A point 314 is the actual cost incurred at the actual bid during the experiment 214 (e.g., for a particular ad group of an ad campaign). The location of the point 314 in the line graph with respect to the lines 310 and 312 can be indicative of accuracy and/or internal consistency of the ad simulation engine 124. In some embodiments, the point 314 falling on the line 310 can indicate that the engine 124 is calculating the simulated performance data 210 accurately. The point 314 falling near the line 312, within the point's 314 confidence bounds or error bars can indicate accuracy of the simulated results generated by the engine 124. The error bars of the point 314 can be calculated utilizing a statistical method such as binomial distribution with clicks being considered random events.

The line 312 illustrates a visualization of the simulated performance data 212 generated by the engine 124 based on the experimentation data 204 (i.e., an arm of the experiment 214 that utilized the experimental bid). The point 316 represents the actual cost incurred during the experiment 214 while the control bid level was utilized. The location of the point 316 in the line graph with respect to the lines 310 and 312 can be indicative of accuracy and/or internal consistency of the ad simulation engine 124. In particular, the point 316 falling on the line 312 can indicate that the engine 124 is calculating simulated performance data e.g., simulated performance 212) accurately. The point 316 falling near the line 310, within the point's 316 confidence bounds or error bars can indicate accuracy of the simulated results generated by the engine 124. The error bars of the point 316 can be calculated utilizing a statistical method such as binomial distribution with clicks being considered random events.

In some embodiments, the placement or location of the lines 310 and 312 in the line graph with respect to each other can indicate accuracy of the engine 124. For example, similar slope of the lines 310 and 312 and/or a measurement of distance between the lines 302 and 304 (e.g., total area between the lines 310 and 312 as a measure of error) indicate that the engine 124 is generating accurate simulated performance data.

FIG. 3C illustrates a user interface 300c displaying how clicks predictions vary with a change in cost. The X-axis of the line graph is measuring cost at different cost levels (e.g., $200, $400, etc.), while the Y-axis is measuring the number of clicks received (e.g., 100 clicks, 200 clicks, 300 clicks). As shown in the legend 326c, the simulated or predicted clicks shown in the line 318 represent the simulated performance data 210, while the clicks in line 320 represent simulated performance data 212. The lines 318 and 320 shown in the line graph in the user interface 300c demonstrate predicted clicks at different cost levels.

A point 322 represents the actual number of clicks that were received at the actual incurred cost, during the experiment 214 when the experimental bid level was used. The location of the point 322 in the line graph with respect to the lines 318 and 320 can be indicative of accuracy and/or internal consistency of the ad simulation engine 124. In some embodiments, the point 322 falling on the line 318 can indicate that the engine 124 is calculating simulated performance 210 accurately. The point 322 falling near the line 320, within the point's 322 confidence bounds or error bars can indicate accuracy of the simulated results generated by the engine 124. The error bars of the point 322 can be calculated utilizing a statistical method such as binomial distribution with clicks being considered random events.

The line 320 illustrates a visualization of the simulated performance data 212 (i.e., predicted clicks at various cost levels) generated by the engine 124 based on experimentation data 204 (i.e., an arm of the experiment 214 that utilized the experimental bid). A point 324 represents the actual number of clicks received during the experiment 214, at the control bid level. The location of the point 322 in the line graph with respect to the lines 318 and 322 can be indicative of accuracy and/or internal consistency of the ad simulation engine 124. In particular, the point 324 falling on the line 320 can indicate that the engine 124 is calculating the simulated performance data 212 accurately. The point 324 falling near the line 320, within the point's 324 confidence bounds or error bars can indicate accuracy of the simulated results generated by the engine 124. The error bars of the point 324 can be calculated utilizing a statistical method such as binomial distribution with clicks being considered random events.

In some embodiments, the placement or location of the lines 318 and 320 in the line graph with respect to each other can indicate accuracy of the engine 124. For example, similar slope of the lines 318 and 320 and/or a measurement of distance between the lines 318 and 320 (e.g., total area between the lines 318 and 320 as a measure of error) indicate that the engine 124 is generating accurate simulated performance data.

The line graphs shown in the user interfaces 300a, 300b, and 300c demonstrate that the predictions generated by the ad change simulation engine 124 are accurate (with predetermined levels of error or noise) based on the shape of the curves, the curves having similar sized jumps, and/or the placement of the points 306, 308, 314, 316, 322 and 324 on the respective lines 302, 304, 310, 312, 318, and 320.

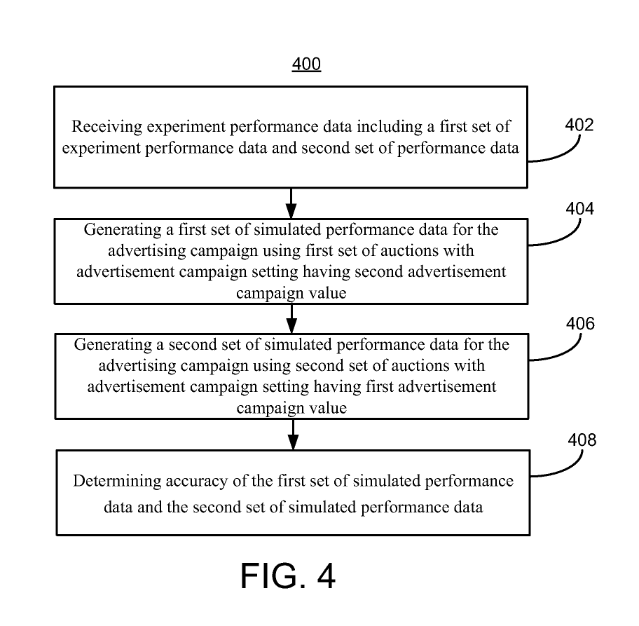

FIG. 4 is a flow diagram of a process 400 for determining accuracy of simulated performance data, in accordance with an illustrative embodiment. The process 400 can be implemented on a computing device. In one embodiment, the process 400 is encoded on a computer-readable medium that contains instructions that, when executed by a computing device, cause the computing device to perform operations of the process 400.

At block 402, experiment performance data associated with an advertising campaign is received. The experiment performance data is generated during a first advertisement campaign experiment by the experimentation engine 122. The received experiment performance data includes a first set of experiment performance data and a second set of experiment performance data. During the advertisement campaign experiment, a first set of auction instances for advertisement space used the first advertisement campaign with a first advertisement campaign setting having a first advertisement campaign value, and a second set of auction instances for advertisement space used the first advertisement campaign with the first advertisement campaign setting having a second advertisement campaign value. For example, the first advertisement campaign setting can be a bid for a particular keyword or for an entire ad group. In this example, the first advertisement campaign value is a specific bid value (e.g., $2). The experiment can be performed for a predetermined period of time.

The first set of experiment performance data can include various advertising campaign performance data (e.g., a total number of impressions and clicks received when the first advertisement campaign setting had the first advertisement campaign value). Similarly, the second set of experiment performance data can include various advertising campaign performance data (e.g., a total number of impressions and clicks received when the first advertisement campaign setting had the second advertisement campaign value).

The advertisement campaign experiment can be running the advertisement campaign for a predetermined period of time using two different advertisement campaign setting values (e.g., two different bid levels). For example, the first advertisement campaign value can be used with a portion of user traffic searching for keywords, on an online search engine, that match keywords in the advertisement campaign, and the second advertisement campaign value can be used with the remaining portion of the user traffic. The first and second set of experiment performance data is generated by the experiment engine 122 or another engine or system associated with the advertisement management system 110.

The first set of auction instances are online search engine auction instances captured during the first experiment with the first advertisement campaign setting having the first advertisement campaign value. The second set of auction instances are online search engine auction instances captured during the first experiment with the first advertisement campaign setting having the second advertisement campaign value.

At block 404, a first set of simulated performance data is generated for the advertising campaign using the first set of auctions with the first advertisement campaign setting having second advertisement campaign value. At block 406, a second set of simulated performance data is generated for the advertising campaign using the second set of auctions instances with the first advertisement campaign setting having first advertisement campaign value. The first and second sets of simulated performance data can be generated by the ad change simulation engine 124 or another engine or system of the advertisement management system 110.

The first set of simulated performance data can include predicted advertising campaign performance data that would have been received by advertising campaign if the first advertising campaign setting had the second advertising campaign value instead of the first advertising campaign value (e.g., a total number of impressions and clicks that would have been received for the first keyword at the second bid value instead of the first bid value). Similarly, the second set of simulated observation performance data can include predicted advertising campaign performance data that would have been received by the advertising campaign if the first advertising campaign setting had the first advertising campaign value instead of the second advertising campaign value (e.g., a total number of impressions and clicks that would have been received for the first keyword at the first bid value instead of the second bid value).

At block 408, accuracy of the first set of performance data and the second set of performance data is determined by comparing the first performance data to the second set of experiment performance data, and by comparing the second performance data to the first set of experiment performance data. One or more metrics can be determined based in part on the first and second sets of simulated performance data and the first and second sets of experiment performance data. For example, metrics can include an average discrepancy percentage between the first set of simulated observation performance data, the second set of simulated observation performance data, first set of observation performance data, and second set of observation performance data.

A visual representation of the one or more metrics and/or the comparison of the performance data to the experiment performance data can be generated and transmitted to a client device. The visual representation can display at least some of the first and second sets of simulated performance data, and the first and second sets of experiment performance data. FIG. 3A-C illustrate exemplary visualizations of the simulated performance data as well as experimentation data.

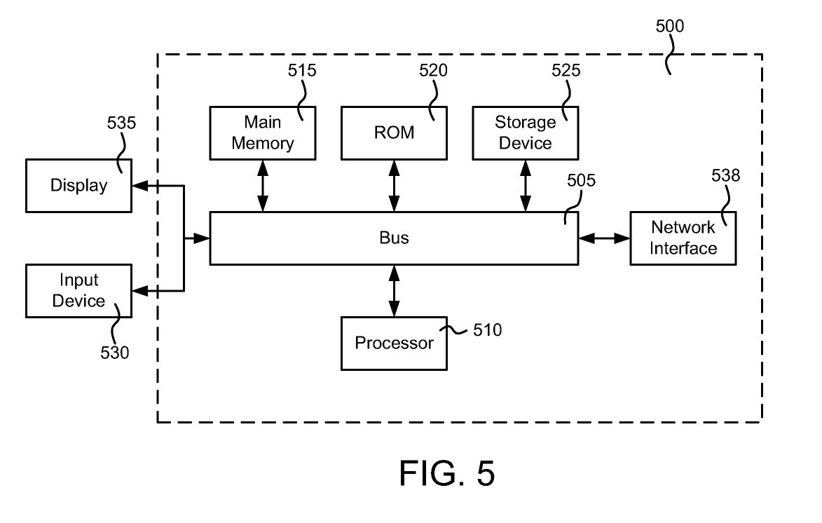

FIG. 5 is a block diagram of a computer system in accordance with an illustrative implementation. The computer system or computing device 500 can be used to implement devices 106 and/or the advertisement management system 110, etc. The computing system 500 includes a bus 505 or other communication component for communicating information and a processor 510 or processing circuit coupled to the bus 505 for processing information. The computing system 500 can also include one or more processors 510 or processing circuits coupled to the bus for processing information. The computing system 500 also includes main memory 515, such as a random access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 510 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

According to various implementations, the processes described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to effect illustrative implementations. Thus, implementations are not limited to any specific combination of hardware circuitry and software.

Although an example computing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” or “processing circuit” encompasses all kinds of apparatus, devices, and machines for processing data, including by way of example a programmable processor, a computer, a system on a chip, or multiple ones, a portion of a programmed processor, or combinations of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computerized method of evaluating a simulation engine, the method comprising:
receiving, by a first computer from an experiment engine of a second computer via a network, experiment performance data associated with an advertisement campaign, the advertisement campaign including:
a first set of experiment performance data including a first number of selections generated during an actual advertisement campaign experiment from a first set of auction instances using the advertisement campaign, the advertisement campaign having a first advertisement campaign setting value; and
a second set of experiment performance data including a second number of selections generated during the actual advertisement campaign experiment from a second set of auction instances using the advertisement campaign, the advertisement campaign having a second advertisement campaign setting value;
generating, by a simulation engine of the first computer using the first set of auction instances after completion of the actual advertisement campaign experiment, a first set of simulated performance data for the advertisement campaign that includes a third number of selections simulated at the second advertisement campaign setting value;
generating, by the simulation engine using the second set of auction instances after completion of the actual advertisement campaign experiment, a second set of simulated performance data for the advertisement campaign that includes a fourth number of selections simulated at the first advertisement campaign setting value;
comparing, by one or more processors of the first computer, the third number of selections of the first set of simulated performance data at the second advertisement campaign setting value with the second number of selections of the second set of experiment performance data to generate a first metric;
comparing, by one or more processors of the first computer, the fourth number of selections of the second set of simulated performance data at the first advertisement campaign setting value with the first number of selections of the first set of experiment performance data to generate a second metric; and
determining, by one or more processors of the first computer, accuracy of the simulation engine based on the first comparison metric and the second comparison metric.

2. The method of claim 1, further comprising determining one or more metrics based in part on the first and second sets of simulated performance data and the first and second sets of experiment performance data.

3. The method of claim 2, wherein the one or more metrics include an average discrepancy percentage from the comparisons.

4. The method of claim 1, wherein the first advertisement campaign setting value is a bid value associated with a keyword of the advertisement campaign.

5. The method of claim 4, wherein, for duration of the advertisement campaign experiment, the first advertisement campaign setting value is assigned a first bid value, and the second advertisement campaign setting value is assigned a second bid value.

6. The method of claim 5, wherein the first set of experiment performance data includes a total number of impressions and clicks received for the keyword at the first bid value, and the second set of experiment performance data includes a total number of impressions and clicks received for the keyword at the second bid value during the duration of the advertisement campaign experiment.

7. The method of claim 5, wherein the first set of simulated performance data includes a total number of impressions and clicks that would have been received for the keyword at the second bid value instead of the first bid value, and the second set of simulated performance data includes a total number of impressions and clicks that would have been received for the keyword at the first bid value instead of the second bid vale.

8. The method of claim 5, further comprising transmitting a visual representation of results of the comparisons.

9. A computerized system comprising:
one or more processing circuits configured to:
receive, from a computer via a network, experiment performance data associated with an advertisement campaign, the advertisement campaign including
a first set of experiment performance data including a first number of selections generated during an actual advertisement campaign experiment from a first set of auction instances using the advertisement campaign, the advertisement campaign having a first advertisement campaign setting value; and
a second set of experiment performance data including a second number of selections generated during the actual advertisement campaign experiment from a second set of auction instances using the advertisement campaign, the advertisement campaign having a second advertisement campaign setting value;
generate, by a simulation engine using the first set of auction instances after completion of the actual advertisement campaign experiment, a first set of simulated performance data for the advertisement campaign that includes a third number of selections simulated at the second advertisement campaign setting value;
generate, by the simulation engine using the second set of auction instances after completion of the actual advertisement campaign experiment, a second set of simulated performance data for the advertisement campaign that includes a fourth number of selections simulated at the first advertisement campaign setting value;
compare the third number of selections of the first set of simulated performance data at the second advertisement campaign setting value with the second number of selections of the second set of experiment performance data to generate a first metric;
compare the fourth number of selections of the second set of simulated performance data at the first advertisement campaign setting value with the first number of selections of the first set of experiment performance data to generate a second metric; and
determine accuracy of the simulation engine based on the first comparison metric and the second comparison metric.

10. The system of claim 9, further comprising determining one or more metrics based in part on the first and second sets of simulated performance data and the first and second sets of experiment performance data.

11. The system of claim 10, wherein the one or more metrics include an average discrepancy percentage from the comparisons.

12. The system of claim 9, wherein the first advertisement campaign setting value is a bid value associated with a keyword of the advertisement campaign.

13. The system of claim 12, wherein, for duration of the advertisement campaign experiment, the first advertisement campaign setting value is assigned a first bid value, and the second advertisement campaign setting value is assigned a second bid value.

14. The system of claim 13, wherein the first set of experiment performance data includes a total number of impressions and clicks received for the keyword at the first bid value, and the second set of experiment performance data includes a total number of impressions and clicks received for the keyword at the second bid value during the duration of the advertisement campaign experiment.

15. The system of claim 13, wherein the first set of simulated performance data includes a total number of impressions and clicks that would have been received for the keyword at the second bid value instead of the first bid value, and the second set of simulated performance data includes a total number of impressions and clicks that would have been received for the keyword at the first bid value instead of the second bid vale.

16. The system of claim 13, wherein the one or more processing circuits are further configured to: transmit a visual representation of results of the comparison.

17. The system of claim 13, wherein the one or more processing circuits are further configured to: transmit a visual representation of the one or more metrics.

18. A computer-readable medium storing instructions that when executed by one or more processors are configured to:
receive, by a first computer from a second computer via a network, experiment performance data associated with an advertisement campaign, the advertisement campaign including:
a first set of experiment performance data including a first number of selections generated during an actual advertisement campaign experiment from a first set of auction instances using the advertisement campaign, the advertisement campaign having a first advertisement campaign setting value; and
a second set of experiment performance data including a second number of selections generated during the actual advertisement campaign experiment from a second set of auction instances using the first advertisement campaign, the advertisement campaign having a second advertisement campaign value;
generate, by a simulation engine using the first set of auction instances after completion of the actual advertisement campaign experiment, a first set of simulated performance data for the advertisement campaign that includes a third number of selections simulated at the second advertisement campaign setting value;
generate, by the simulation engine using the second set of auction instances after completion of the actual advertisement campaign experiment, a second set of simulated performance data for the advertisement campaign that includes a fourth number of selections simulated at the first advertisement campaign setting value;
compare, by one or more processors of the first computer, the third number of selections of the first set of simulated performance data at the second advertisement campaign setting value with the second number of selections of the second set of experiment performance data;
compare, by one or more processors of the first computer, the fourth number of selections of the second set of simulated performance data at the first advertisement campaign setting value with the first number of selections of the first set of experiment performance data to generate a second metric; and
determine, by one or more processors of the first computer, accuracy of the simulation engine based on the first comparison metric and the second comparison metric.

19. The computer-readable medium of claim 18, wherein the first advertisement campaign setting value is a bid value associated with a keyword of the advertisement campaign.

20. The computer-readable medium of claim 18, wherein, for duration of the advertisement campaign experiment, the first advertisement campaign setting value is assigned a first bid value, and the second advertisement campaign setting value is assigned a second bid value.
